(19) United States
(12) Patent Application Publication
(10) Pub. No.: US 2011/0129671 A1
(43) Pub. Date: Jun. 2, 2011

(54) METHOD OF PRODUCING QUANTUM CONFINED INDIUM NITRIDE STRUCTURES

(75) Inventor: Nicholas John Edgington, Cary, NC (US)

(73) Assignee: Quantum Confined, Ltd., Allentown, PA (US)

(21) Appl. No.: 12/996,135

(22) PCT Filed: Jun. 3, 2009
(86) PCT No.: PCT/US09/46102

§ 371 Date: Dec. 3, 2010

Related U.S. Application Data
(60) Provisional application No. 61/058,264, filed on Jun. 3, 2008.
(60) Provisional application No. 61/149,881, filed on Feb. 4, 2009.

(51) Int. Cl. C01B 21/06; C01B 21/076; C01B 21/072; B32B 5/16; B01J 19/08; B01J 19/12; B82Y 40/00

(52) U.S. Cl. 428/402; 423/409; 423/411; 423/412; 422/186.04; 422/186; 977/774

(57) ABSTRACT

A method and system for producing quantum confined metal nitride. The method includes immersing two electrodes into a nitrogen environment wherein at least one electrode includes an indium electrode, and passing an arc between the electrodes. The system includes a container for holding a bath of liquid nitrogen, two electrodes disposed inside the container so as to be immersed into the bath of liquid nitrogen, at least one of the two electrodes being a metal electrode, and a voltage source connected to the electrodes and configured to pass an arc between the electrodes.

### BACKGROUND OF THE INVENTION

1. Field of Invention

The invention relates to methods and systems for producing indium nitride nanostructures using thermal plasma.

2. Discussion of the Background

Indium nitride is a composition that is an extremely useful material for a wide range of applications. Especially if indium nitride could be effectively and economically produced in the form of quantum confined nanostructures, then it would be valuable in applications ranging from photovoltaic materials to quantum computing applications. There are limitations to the use of indium nitride in these applications because of a number of problems involved in the conventional fabrication of structures with indium nitride. The two main methods of making such structures currently are by wet chemistry or chemical vapor deposition (CVD). The wet chemical technique requires the use of a number of dangerous precursors, such as arsenic and phosphorus; making these chemical processes difficult to control and dangerous.

These techniques with all their problems present limitations, and the CVD technique has, to date, only been used to create epitaxially connected structures.

### SUMMARY OF THE INVENTION

In one embodiment of the invention, there is provided a method for producing quantum confined indium nitride nanostructures. The method includes immersing two electrodes into a nitrogen environment wherein at least one electrode includes an indium electrode, and passing an arc between the electrodes.

In one embodiment of the invention, there is provided a system for producing quantum confined indium nitride nanostructures. The system includes a container for holding a bath of liquid nitrogen, two electrodes disposed inside the container so as to be immersed into the bath of liquid nitrogen, at least one of the two electrodes being an indium electrode, and a voltage source connected to the electrodes which is configured to pass an arc between the electrodes.

In one embodiment of the invention, there is provided a method for producing quantum confined metal nitride structures. The method includes providing a thermal plasma including a medium of nitrogen gas, nitrogen ions, metal vapor, and metal ions, and reacting the nitrogen ions with at least one of the metal vapor and the metal ions to form the quantum confined metal nitride particle structures.

In one embodiment of the invention, there is provided a system for producing quantum confined indium nitride nanostructures. The system includes a container for holding an atmosphere of a nitrogen containing gas, two electrodes disposed inside the container, at least one of the two electrodes having an indium containing electrode, and a voltage source connected to the electrodes and configured to pass an electrical arc between the electrodes.

In one embodiment of the invention, there is provided a system for producing quantum confined indium nitride nanostructures. The system includes a container for holding an atmosphere of a nitrogen containing gas, an indium metal substrate, and a magnetron disposed to heat the surface of the indium metal substrate and produce localized electrical arcs with microwave radiation.

It is to be understood that both the foregoing general description of the invention and the following detailed description are exemplary, but are not restrictive of the invention.

### BRIEF DESCRIPTION OF THE FIGURES

A more complete appreciation of the invention and many of the attendant advantages thereof will be readily obtained as the same becomes better understood by reference to the following detailed description when considered in connection with the accompanying drawings, wherein:

FIG. 1 is a spectrum of fluorescence from indium nitride quantum dots of the invention irradiated with UV radiation;

FIG. 2 is a schematic showing a system for producing metal nitride quantum dots of the invention;

FIG. 3 is a schematic showing another system for producing metal nitride quantum dots of the invention; and

FIG. 4 is a schematic showing a microwave system for producing metal nitride quantum dots of the invention.

### DETAILED DESCRIPTION OF THE INVENTION

The present invention relates to the discovery that quantum confined metal nitride structures (including, but not limited to, indium nitride, aluminum nitride, gallium nitride, and a titanium nitride) can be made under appropriate conditions without the general difficulty and danger of the previously used methods. The present invention also relates to the discovery that non-quantum confined metal nitride structures (including, but not limited to, indium nitride, aluminum nitride, gallium nitride, and a titanium nitride) can be made under appropriate conditions without the general difficulty and danger of the previously used methods.

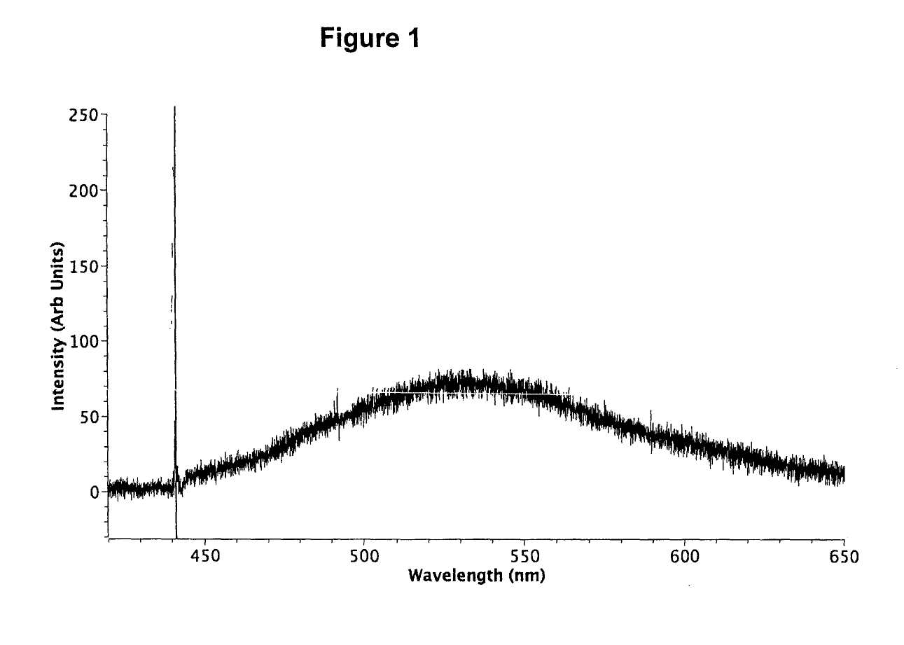

Indium nitride quantum dots are in one embodiment of the invention indium nitride spheroid structures with dimensions small enough to produce quantum confinement in which the dimensions of the nanoparticle are approximately equal to or less than the Bohr Exciton radius of the particle (approximately 10 nm). Such quantum dots are easily distinguished from other structures because they fluoresce in the presence of light with a wavelength shorter than the wavelength of fluorescence. In the various embodiments of the invention described herein, indium nitride particles have been produced that fluoresce in the green wavelength range (i.e., quantum dots). The spectral analysis of these “green dots” when illuminated by ultraviolet light is shown in FIG. 1. Electron microscopy indicates that these quantum dots are in the shape of rhomboids about 10 nm in diameter. Other sizes and shapes of nanoparticles have also been produced using the various processes of this invention, but the “green dot rhomboids” are the most visible to date and have immediate commercial application.

Plasmas are used in one embodiment of the invention to produce the indium nitride structures described herein. Plasmas exist in many forms in the universe and on Earth. Examples of plasmas include the matter of the sun, the glowing material inside a fluorescent lamp, lightning, the glowing matter in electrical arcs between two electrodes of opposite charge, and flames. For practical purposes, this invention describes the use of terrestrial plasmas.

The temperature of a plasma is a measure of the thermal kinetic energy per particle. In most cases, the electrons are close enough to thermal equilibrium that their temperature is relatively well-defined. Because of the large difference in mass, the electrons come to thermodynamic equilibrium amongst themselves much faster than the electrons come into equilibrium with the ions or neutral atoms. For this reason the “ion temperature” may be very different from (usually lower than) the “electron temperature.” This is especially common in weakly ionized technological plasmas, where the ions are often near the ambient temperature. Since the mass of the ions and neutrals is so much higher than that of the electrons, the apparent (or bulk) temperature of the plasma may be “cold”—typically room temperature—even though the electron temperature is thousands of degrees Celsius higher.

Based on the relative temperatures of the electrons, ions and neutral particles, plasmas are classified as “thermal” or “non-thermal.” Thermal plasmas have electrons and the heavy particles at the same temperature, i.e. they are in thermal equilibrium with each other. Non-thermal plasmas on the other hand have the ions and neutral particles at a much lower temperature (normally room temperature) than the, electrons which are much “hotter.”

Temperature controls the degree of plasma ionization. A plasma is sometimes referred to as being “hot” if it is highly ionized, or “cold” if only a small fraction (for example 1%) of the gas molecules is ionized (but other definitions of the terms “hot plasma” and “cold plasma” are common). Even in a “cold” plasma, the electron temperature is still typically several thousand degrees Celsius. Plasmas utilized in “plasma technology” are usually cold in this sense.

Accordingly, one method of the invention for the production of indium nitride quantum dots includes the production of a thermal plasma including ions of both indium and nitrogen. Another method of the invention for the production of metal nitride quantum dots and larger metal nitride particles includes the production of a thermal plasma including ions of both metal (including, but not limited to, indium, aluminum, gallium, and/or titanium) and nitrogen. Thermal plasmas may be formed in various embodiments of the invention by creating an electrical discharge in a number of ways, many (but not all) of which involve producing an electrical arc between two electrodes in an environment of substantially pure nitrogen or nitrogen mixed with a noble gas such as helium, neon, argon, krypton, or xenon and wherein at least one of the electrodes includes indium metal. It is known in welding and other fields that mixing even small amounts of a noble gas into the gaseous environment through which an electrical discharge passes will result in a more stable and a longer-lasting discharge.

The plasma melts the surface of the indium (>430° K) and volatilizes the surface of the metal to a degree sufficient to create a significant vapor pressure in the molten surface of the metal to provide indium into the gas phase to ionize and react with the nitrogen ions. The thermal plasma provides indium and nitrogen ions in the plasma at sufficient temperature to react and form indium nitride and to agglomerate into indium nitride nano-particles of sufficiently small diameter to serve as quantum confined structures. In other embodiments, larger diameter non-quantum confined indium nitride particles can be formed.

Although there is no established minimum temperature at which all of these criteria are met and some parameters such as degree of dissociation increase continuously over a wide temperature range, it is believed that one example of temperature of the plasma suitable for the invention is at least 1000° C. to produce a significant yield of indium nitride quantum dots. However, other temperatures such as at least 500° C., at least 600° C., at least 700° C., and at least 900° C. are not precluded as the temperature will affect the yield. The optimal temperatures will to some degree be dependent on the reactivity of the metal being nitrided. Previous experiments by the inventors using non-thermal plasmas failed to produce any detectable indium nitride quantum dots. In another example of the invention, an electric arc has been used to produce indium nitride quantum dots. The bulk temperature in an electric arc can be from 5,000-28,000° C., depending on the voltage and current available.

In one embodiment of the invention, the production of metal nitride quantum dots (such as indium nitride quantum dots discussed below) appears to be enhanced by rapid thermal quenching of the indium nitride after it is formed. This effect is based on qualitative observations, which show the effect to be dramatic. It is believed that slower quenching may result in larger crystals that are too large to exhibit quantum confined properties.

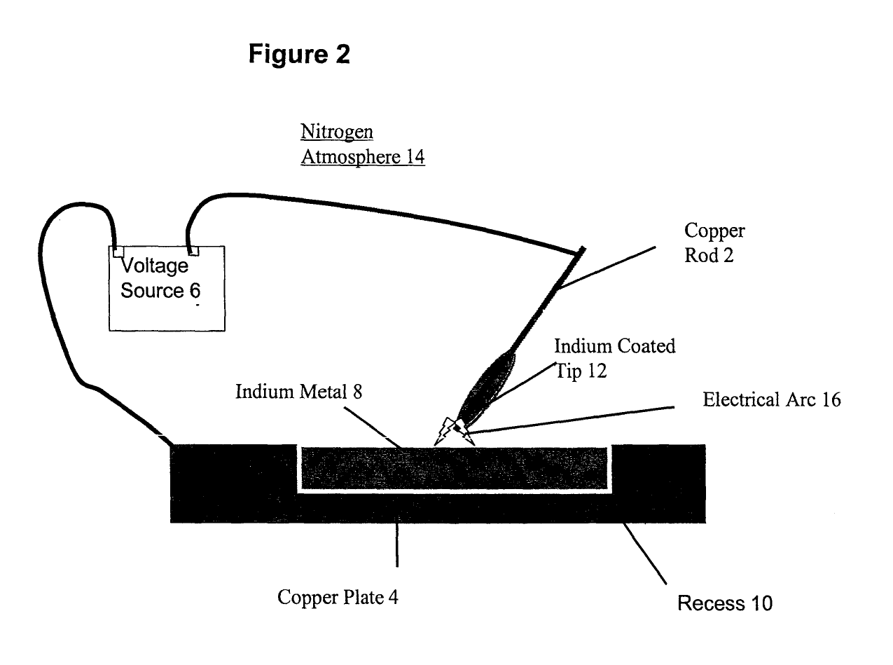

FIG. 2 is a schematic showing a system for producing metal nitride quantum dots of the invention. In the embodiment of the invention shown in FIG. 2, two electrodes 2, 4 are connected to the poles of a voltage source 6 (e.g., a 1.2 volt car battery) which is a source of voltage and high instantaneous electrical current. One electrode 4 includes a disc of indium metal 8 cupped inside a recess 10 in a copper plate electrode 4. The other electrode 2 includes a copper rod coated with indium metal 12. The copper plate and rod are used to provide a supporting structure to the indium, which otherwise would melt and lose its shape. The electrodes are in one embodiment contained in a chamber (not shown) holding a nitrogen gas atmosphere 14. A mechanical system (not shown) can be used for lowering the rod electrode 2 until it is near enough to the plate electrode 4 to strike an arc 16. If the position of the electrodes is not controlled precisely, at this low voltage and high current, the two electrodes can touch and weld themselves together. After a few seconds of arc, illumination with an ultraviolet lamp has revealed green fluorescent patches of quantum dots on the surface of the indium, copper and chamber. These patches can be scraped off and collected.

While not limited to a particular theory, the following is provided for the purpose of illustrating the mechanisms involved in the invention for the formation of metal nitride structures. For the approach described above, the DC voltage creates a continuous stream of indium ions travelling from the positive electrode to the negative electrode. The nitrogen ions tend to exist at the outer surface of the plasma plume, while the indium ion stream tends to flow near the center of the plume. This results in sub-optimal mixing which limits the rate of production of indium nitride quantum dots. This effect can be lessened by operating the device in FIG. 2 on an AC current. According to this embodiment, with each cycle of the AC current, the polarity of the plasma plume switches. The plasma plume under AC current operation is established, extinguished, and re-established with reverse polarity on each cycle. This creates improved mixing between the indium ions and the nitrogen ions, resulting in increased production of indium nitride quantum dots. Another benefit of AC operation is that, at high frequencies, the current flowing in the electrodes tends to be confined to the surface of the electrode due to the well-known skin effect. Thus at high frequency any resistance heating that occurs in electrodes will preferentially heat the surface of the metal where it is beneficial rather than the core of the metal. Since indium metal has an extremely low melting point (156.6° C.), this beneficial effect may help prevent melting the electrodes and can minimize the need for stiffeners such as the depicted copper rods in FIG. 2.

In one embodiment of the invention, higher operating voltages between the electrodes permit a greater spacing between the electrodes when an arc is initiated. This increases the length of the plasma plume and increases the volume of the plume, thereby increasing the volume of plasma in which the reaction between indium and nitrogen ions can occur. To the extent that indium and nitrogen ions exist in the plume as distinct shells, filaments or other non-homogeneous streams within the plume, an increased plume length increases the surface area at the interface between different streams of ions.

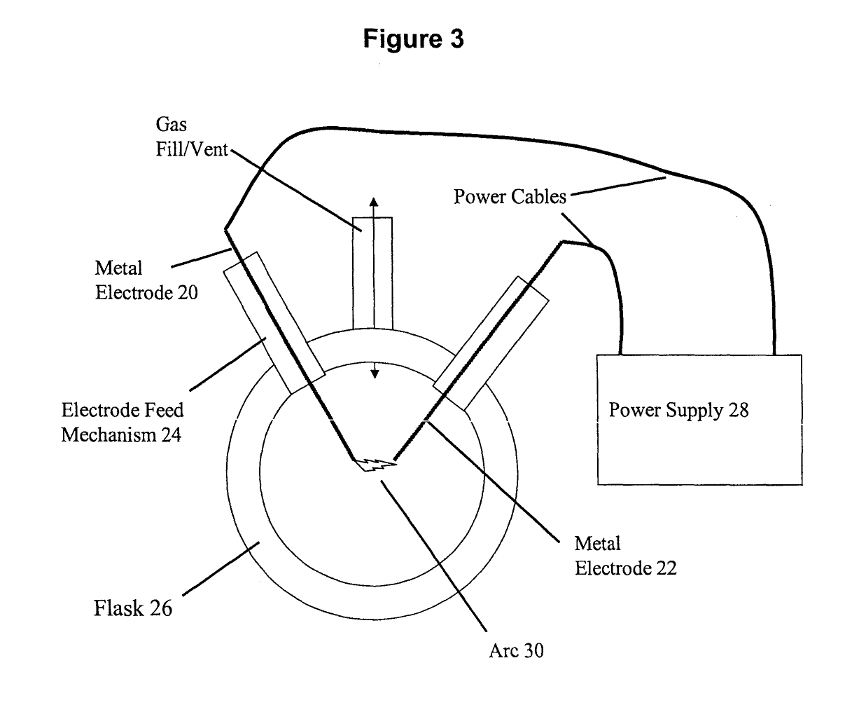

FIG. 3 is a schematic showing another system for producing metal nitride quantum dots of the invention. In this embodiment of the invention, two metal electrodes 20, 22 (including, but not limited to, indium electrodes, aluminum electrodes, gallium electrodes, or titanium electrodes) are placed on mechanical positioners (such as the electrode feed mechanism 24 in FIG. 3) so that the electrodes 20, 22 can be lowered diagonally on converging paths into a flask 26 full of nitrogen gas as shown in FIG. 3. In other embodiments of the invention, metals such as copper, zinc, manganese, tin, or lead can be used as the electrode materials providing a source metal for nitride formation. The electrodes 20, 22 can be connected to a power supply 28 (source of AC or DC current and voltage), and the electrodes 20, 22 can be inserted farther into the flask 26 until an arc 30 forms between the tips of the electrodes 20, 22. As nitrogen is consumed, more gas can be injected into the flask 26. As the electrodes are consumed, these consumable electrodes 20, 22 can be inserted farther into the flask to maintain tip positions that will sustain an arc. Metal nitride particles including for example indium nitride quantum dots can be harvested from the inside of the flask 26. Although the flask 26 in FIG. 3 is shown as a one-piece vessel, flask 26 can be made in separate pieces for opening of the flask and removal of the metal nitride particles.

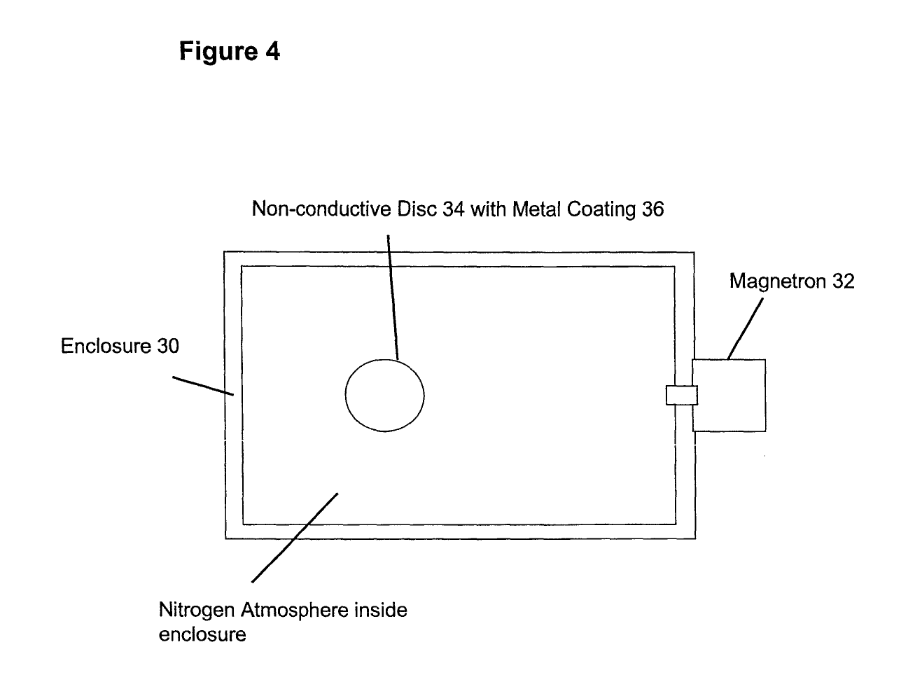

FIG. 4 is a schematic showing a microwave system for producing metal nitride quantum dots of the invention. In this embodiment of the invention, thermal plasmas can be created on a metal surface by high frequency electromagnetic waves such as microwaves. In one example of this embodiment, a microwave cavity formed by enclosure 30 can be powered for example by a magnetron or other microwave source 32. The enclosure 30 can be filled with nitrogen gas, and a non-conductive surface 34 (such as a glass or ceramic flat plate or a quartz wafer) covered with a thin metal film 36 can be inserted into the microwave cavity 30. The thin metal film 36 on the non-conductive surface 34 forms a plate. When the microwave power is turned on, electrical arcs will form on the surface of the plate, ionizing both the metal and nitrogen adjacent to the plate. Metal nitride quantum dots and metal nitride particles can then be formed in the resulting thermal plasma.

There are many ways known in the art to create other thermal plasmas which can be used in the present invention to produce nitrogen and metal ions by exposure of metal to a nitrogen-containing thermal plasma.

In various of the embodiments for producing for example indium nitride quantum dots or particles, only one of the electrodes is required to be indium. The other electrode can be made of another conductive material (including, but not limited to, tungsten) that has a higher melting point and a lower vapor pressure than indium. This tungsten counter electrode embodiment can be advantageous because the electrical resistance of indium decreases dramatically as the metal approaches its melting point, whereas the resistivity of tungsten does not increase as much at that same temperature. For the same reason, an electrode made of a copper rod with an indium coating on the tip can have advantages in operation compared to a pure indium electrode. In designing the electrodes, however, it is important to avoid designs where the plasma will contact a metal that may participate in the indium/nitrogen reaction. For example, if the arc contacts the surface of a copper supporting structure, copper ions will be produced and will contaminate the product.

Rapid quenching of the nanostructures being formed in the thermal plasma appears to be important to increase the yield of quantum dots. Such quenching can be achieved in a number of ways. In one embodiment, the electrical discharge that results in thermal plasma is produced near one or more thermally conductive surfaces in the reaction chamber. In one embodiment, the quenching surfaces are cooled with chilled water or another cooling medium. The inventor has observed that the resulting “green dots” adhere to the surface of the chilled thermally conductive material.

The inventor has observed that production of “green dots” is greatly increased when the “green dots” are formed in thermal plasma below the surface of a bath of liquid nitrogen. Various reasons to explain this phenomenon include:
The extremely low temperature of the liquid nitrogen (i.e., −196° C.) causes ultra-rapid quenching.
The density of the liquid nitrogen results in a greater density of nitrogen ions in the plasma.
The primary source of “green dot” production is at surface of the bubbles—the interface between thermal plasma and the liquid nitrogen- formed when the energy of the plasma boils the liquid nitrogen locally.
   It is not yet known which (if any) of these reasons is the most accurate explanation of the observed phenomenon.

Liquid nitrogen as used herein refers to diatomic nitrogen in liquid form at cryogenic temperatures. A high voltage arc as used herein refers to a voltage in a range from about 10 V to about 10,000 V. However, in practice, the generation of the arc will depend on factors such as for example the breakdown strength of the nitrogen source, the electrode separation, and the electrode shape.

Although the methods described herein were invented to produce indium nitride nanostructures, these methods can also be used to produce nanostructures of other metal nitrides. In other embodiments of the invention, metals from Group IIIA of the periodic table (aluminum, gallium, or indium) and other metals including, but not limited to, titanium, copper, zinc, manganese, tin, or lead may be combined with nitrogen to form metal nitrides including nitride semiconductor nanodots and other metal nitride particles, where the formation of these metal nitrides occurs from a thermal plasma.

III-V semiconductor nanodot materials (including, but not limited to, the indium nitride nanodots) are useful in photovoltaic applications. In other embodiments of the invention, nanoparticle nitrides of metals from other Groups of the periodic table would have applications in other fields such as pigments and medical applications. For example, III-V semiconductor nanostructures are used as markers where the nanostructures attach to certain types of tissues and mark that tissue by the fluorescence of the nanostructures.

Thus, the present invention in general includes methods and systems (as described above) for producing metal nitride structures. These methods and systems provide a thermal plasma having a bulk temperature >1000° C. in a medium of nitrogen gas, nitrogen ions, metal vapor, and metal ions. These methods and systems react the nitrogen ions with at least one of the metal vapor and the metal ions to form the metal nitride structures.

The thermal plasmas can be provided with at least one of indium and indium ions for indium nitride formation. The thermal plasmas can be provided with at least one of aluminum and aluminum ions for aluminum nitride formation. The thermal plasmas can be provided with at least one of gallium and gallium ions for gallium nitride formation. The thermal plasmas can be provided with at least one of titanium and titanium ions for titanium nitride formation. The thermal plasmas can be provided with at least one of copper and copper ions for copper nitride formation. The thermal plasmas can be provided with at least one of zinc and zinc ions for zinc nitride formation. The thermal plasmas can be provided with at least one of manganese and manganese ions for manganese nitride formation. The thermal plasmas can be provided with at least one of tin and tin ions for tin nitride formation.

The thermal plasmas can be provided with at least one of lead and lead ions for lead nitride formation. A combination of different metal ions of these and other metals could also be provided to the thermal plasma for the production of metal alloy or metal doped nitrides.

A noble gas of 0.1-10% can be added to the nitrogen gas as part of the thermal plasma. The noble gas can include at least one of helium, argon, neon, xenon or krypton. The metal nitride being formed can be quenched by contact of the metal nitride being formed with the surface of a liquid or solid that has a temperature lower than 1000° C. The metal nitride quenching can occur in the presence of at least one of indium and indium ions, or at least one of aluminum and aluminum ions, or at least one of gallium and gallium ions, or at least one of titanium and titanium ions, or at least one of copper and copper ions, or at least one of zinc and zinc ions, or at least one of manganese and manganese ions, or at least one of tin and tin ions, or at least one of lead and lead ions. The metal nitride quenching can occur under a bath of liquid nitrogen. The thermal plasma, can be produced underneath a bath of liquid nitrogen.

The thermal plasma can be formed by passing an electrical arc between the two electrodes. The electrical arc can be passed between the two electrodes by applying a DC voltage in a range between 10 and 10,000 V between the two electrodes. The electrical arc can be passed between the two electrodes by applying an AC voltage between the two electrodes. The electrical arc can be passed between the two electrodes by applying an AC voltage in a range between 10 and 10,000 V between the two electrodes.

From the thermal plasmas, the metal nitride particles being formed can be quenched at a rate to produce quantum dot metal nitride structures From the thermal plasmas, at least one of aluminum nitride, indium nitride, gallium nitride, titanium nitride, copper nitride, zinc nitride, manganese nitride, tin nitride, and lead nitride structures can be formed.

The nitride structures produced in the invention include a nitride structure produced by a thermal plasma in a nitrogen environment, which includes a metal nitride particle having at least one dimension less than 100 nm, where the metal nitride particle is a gas-plasma-consolidated metal nitride particle. The gas-plasma-consolidated metal nitride particle can exhibit photoluminescence in the range of 450-600 nm upon irradiation with a shorter wavelength source. The gas-plasma-consolidated metal nitride particle can be at least one of an indium nitride, an aluminum nitride, a gallium nitride, a titanium nitride, a copper nitride, a zinc nitride, a manganese nitride, a tin nitride, or a lead nitride or a combination thereof or with other metals or dopants.

Numerous modifications and variations of the invention are possible in light of the above teachings. It is therefore to be understood :hat within the scope of the appended claims, the invention may be practiced otherwise than as specifically described herein.

1. A method for producing quantum confined indium nitride structures, comprising:
immersing two electrodes into a nitrogen environment wherein at least one electrode comprises an indium electrode; and
passing an arc through the electrodes.

2. The method according to claim 1, wherein immersing comprises immersing two indium electrodes into the bath of liquid nitrogen.

3. The method according to claim 1, wherein passing an arc comprises applying a voltage in a range between 10 and 10,000 V between the two electrodes.

4. A system for producing quantum confined indium nitride structures, comprising:
a container for holding a bath of liquid nitrogen;
two electrodes disposed inside the container so as to be immersed into the bath of liquid nitrogen;
at least one of the two electrodes comprising an indium electrode; and
a voltage source connected to the electrodes and configured to pass an arc between the electrodes.

5. The system according to claim 4, wherein both of the electrodes comprise indium electrodes.

6. The system according to claim 4, wherein the voltage source is configured to provide a voltage in a range between 10 and 2000 V.

7. A method for producing metal nitride structures, comprising:
providing a thermal plasma comprising a medium of nitrogen gas, nitrogen ions, metal vapor, and metal ions; and
reacting said nitrogen ions with at least one of said metal vapor and said metal ions to form the metal nitride particle structures.

8. The method of claim 7, wherein providing a thermal plasma comprises:
providing in the thermal plasma at least one of indium and indium ions, or at least one of aluminum and aluminum ions, or at least one of gallium and gallium ions, or at least one of titanium and titanium ions, or at least one of copper and copper ions, or at least one of zinc and zinc ions, or at least one of manganese and manganese ions, or at least one of tin and tin ions, or at least one of lead and lead ions.

9. The method of claim 7, further comprising:
adding 0.1-10% of a noble gas comprising at least one of helium, argon, neon, xenon or krypton to the thermal plasma.

10. The method of claim 7, further comprising:
quenching the metal nitride being formed by contact of the metal nitride being formed with the surface of a liquid or solid that has a temperature lower than 1000° C.

11. The method of claim 10, wherein quenching the metal nitride being formed comprises:
quenching in the presence of at least one of indium and indium ions, or in the presence of at least one of aluminum and aluminum ions, or in the presence of at least one of gallium and gallium ions, or in the presence of at least one of titanium and titanium ions, or in the presence of at least one of copper and copper ions, or in the presence of at least one of zinc and zinc ions, or in the presence of at least one of manganese and manganese ions, or in the presence of at least one of tin and tin ions, or in the presence of at least one of lead and lead ions.

12. The method of claim 10, wherein quenching the metal nitride being formed comprises:
quenching under a bath of liquid nitrogen.

13. The method of claim 7, wherein providing a thermal plasma comprises:
forming the thermal plasma underneath a bath of liquid nitrogen.

14. The method of claim 7, wherein providing a thermal plasma comprises:
forming the thermal plasma by passing an electrical arc between the two electrodes.

15. The method of claim 14, wherein providing a thermal plasma comprises:
passing the electrical arc by applying a DC voltage in a range between 10 and 10,000 V between the two electrodes.

16. The method of claim 14, wherein providing a thermal plasma comprises:
passing the electrical arc by applying an AC voltage between the two electrodes.

17. The method of claim 14, wherein providing a thermal plasma comprises:
passing the electrical arc by applying an AC voltage n a range between 10 and 10,000 V between the two electrodes.

18. The method of claim 7, further comprising:
quenching the metal nitride being formed at a rate to produce quantum dot metal nitride structures from the thermal plasma.

19. The method of claim 7, further comprising:
forming at least one of aluminum nitride, indium nitride, gallium nitride, titanium nitride, copper nitride, zinc nitride, manganese nitride, tin nitride, and lead nitride structures from the thermal plasma.

20. A system for producing metal nitride structures, comprising:
a container for holding an atmosphere of a nitrogen containing gas;
two electrodes disposed inside the container;
at least one of the two electrodes comprising a metal containing electrode; and
a voltage source connected to the electrodes and configured to pass an electrical arc between the electrodes.

21. The system according to claim 20, wherein one or both of the electrodes comprise at least one of an indium electrode, an aluminum electrode, a gallium electrode, a titanium electrode, a copper electrode, a zinc electrode, a manganese electrode, a tin electrode, or a lead electrode.

22. The system according to claim 20, wherein the voltage source is configured to provide a voltage in a range between 10 and 10,000 V.

23. The system according to claim 22, wherein the voltage is at least one of an AC voltage or a DC voltage source or a combination thereof.

24. The system according to claim 20, wherein:
said container comprises a bath of liquid nitrogen; and
both electrodes are immersed in the bath of liquid nitrogen.

25. The system according to claim 20, wherein:
said container includes 0.1-10% of a noble gas comprising at least one of helium, neon, argon, krypton, or xenon.

26. A system for producing metal nitride structures, comprising:
a container for holding an atmosphere of a nitrogen containing gas;
a metal substrate; and
a microwave source to heat the surface of the metal substrate with microwave radiation.

27. The system of claim 26, wherein the metal substrate is less than 1 mm thick and more than one square centimeter in area.

28. The system of claim 26, wherein the metal substrate comprises at least one of an indium metal, an aluminum metal, a gallium metal, a titanium metal, a copper metal, a zinc metal, a manganese metal, a tin metal, or a lead metal.

29. The system of claim 28, where the metal substrate is disposed on the surface of a non-conducting material.

30. The system according to claim 26, wherein:
said container comprises a bath of liquid nitrogen.

31. A metal nitride structure produced by a thermal plasma in a nitrogen environment, comprising:
a metal nitride particle having at least one dimension less than 100 nm; and
said metal nitride particle comprising a gas-plasma-consolidated metal nitride particle.

32. The structure of claim 31, wherein the gas-plasma-consolidated metal nitride particle exhibits photoluminescence in the range of 450-600 nm upon irradiation with a shorter wavelength source.

33. The structure of claim 31, wherein the gas-plasma-consolidated metal nitride particle comprises at least one of an indium nitride, an aluminum nitride, a gallium nitride, a titanium nitride, a copper nitride, a zinc nitride, a manganese nitride, a tin nitride, or a lead nitride or a combination thereof or with other metals or dopants.
